(19) United States
(12) Patent Application Publication
(10) Pub. No.: US 2002/0165998 A1
(43) Pub. Date: Nov. 7, 2002

(54) Method and apparatus for meta object facility repository event notification

(75) Inventors: Petr Hrebejk, Usti nad Labem (CZ); Martin Matula, Praha (CZ)

Correspondence Address: David B. Ritchie, THELEN REID & PRIEST LLP, P.O. Box 640640, San Jose, CA, 95164-0640, US

(73) Assignee: Sun Microsystems, Inc., a Delaware Corporation

(21) Appl. No.: 10/072,693

(22) Filed: Feb. 6, 2002

Related U.S. Application Data
(60) Provisional application No. 60/288,749, filed on May 3, 2001.

(51) Int. Cl. G06F 9/46

(52) U.S. Cl. 709/318

(57) ABSTRACT

Meta object facility repository event notification may be accomplished through the use of listener interfaces implemented by event listeners and event source interfaces implemented by objects at the repository. The listeners may register for event notifications of a particular type by passing a registration call for the event type to an appropriate event source interface. Additionally, listeners may register for listening to event notifications of any combination of event sub-types by passing a registration call (together with a bitmask indicating the event sub-types combinations) to a combination event type source interface. If an event occurs, an event object (describing the occurred event) is created by the event source and then it is passed via a notification call to each of the listeners registered for notifications of this particular event type or sub-type. This provides notification of the occurrence of events to the listeners.

### CROSS REFERENCE TO RELATED APPLICATIONS

This application claims the benefit of provisional patent application Serial No. 60/288,749 filed May 3, 2001 in the name of inventors Petr Hrebejk and Martin Matula and entitled “Method and Apparatus for Meta Object Facility Repository Event Notification”, Attorney Docket No. SUN-P6327PSP.

### FIELD OF THE INVENTION

The present invention relates to the field of computer science. More particularly, the present invention relates to a method and apparatus for Meta Object Facility (MOF) repository event notification.

### BACKGROUND OF THE INVENTION

Today's Internet-driven economy has accelerated users' expectations for unfettered access to information resources and transparent data exchange among applications. One of the key issues limiting data interoperability today is that of incompatible metadata. Metadata is information about other data, or simply data about data. Metadata is typically used by tools, databases, applications and other information processes to define the structure and meaning of data objects.

Unfortunately, most applications are designed with proprietary schemes for modeling metadata. Applications that define data using different semantics, structures and syntax are difficult to integrate, impeding the free flow of information access across application boundaries. This lack of metadata interoperability hampers the development and efficient deployment of numerous business solutions. These solutions include data warehousing, business intelligence, business-to-business exchanges, enterprise information portals and software development.

An improvement is made possible by establishing standards based upon Extensible Markup Language (XML) Document Type Definitions (DTDs). However, DTDs lack the capability to represent complex, semantically rich, hierarchical metadata.

A further improvement is made possible by the Meta Object Facility (MOF) specification. MOF is described in a text entitled “Meta Object Facility (MOF) Specification”, Object Management Group, Inc., version 1.3, March 2000. The MOF specification defines a standard for metadata management. The goal of MOF is to provide a framework and services to enable model and metadata driven systems. The MOF is a layered metadata architecture consisting of a single meta-metamodel (M3), metamodels (M2) and models (M1) of information. Each meta level is an abstraction of the meta level below it. These levels of abstraction are relative, and provide a visual reference of MOF based frameworks. Metamodeling is typically described using a four-layer architecture. These layers represent different levels of data and metadata. Layers M1, M2 and M3 are depicted in FIG. 1A. FIG. 1B includes a summary and example of each layer.

The information layer (also known as the M0 or data layer) refers to actual instances of information. These are not shown in FIG. 1A, but examples of this layer include instances of a particular database, application data objects, etc.

The model layer 100 (also known as the M1 or metadata layer) defines the information layer. The model layer 100 describes the format and semantics of the data. The metadata specifies, for example, a table definition in a database schema that describes the format of the M0 level instances. A complete database schema combines many metadata definitions to construct a database model. The M1 layer 100 represents instances (or realizations) of one or more metamodels.

The metamodel layer 105 (also known as the M2 or meta-metadata layer) defines the model layer. The metamodel layer 105 describes the structure and semantics of the metadata. The metamodel specifies, for example, a database system table that describes the format of a table definition. A metamodel can also be thought of as a modeling language for describing different kinds of data. The M2 layer represents abstractions of software systems modeled using the MOF Model. Typically, metamodels describe technologies such as relational databases, vertical domains, etc.

The meta-metamodel (M3) layer 110 defines the metamodel layer. The meta-metamodel layer 110 describes the structure and semantics of the meta-metadata. It is the common “language” that describes all other models of information. Typically, the meta-metamodel is defined by the system that supports the metamodeling environment. In the case of relational databases, the meta-metamodel is hard-wired by the Structured Query Language (SQL) standard.

In addition to the information-modeling infrastructure, the MOF specification defines an Interface Definition Language (IDL) mapping for manipulating metadata. More specifically, for any given MOF compliant metamodel, the IDL mapping generates a set of Application Program Interfaces (APIs) that provide a common IDL programming model for manipulating the information contained in any instance of that metamodel. The MOF model itself is a MOF compliant model. Therefore, the MOF model can be described using the MOF. Consequently, APIs used to manipulate instances of the MOF Model (i.e., metamodels) conform to the MOF to IDL mapping.

Other mappings may be used to manipulate metadata. The mappings define how to generate a set of APIs that provide a common programming model for manipulating metadata of any MOF compliant model. Using the mappings, applications and tools that specify their interfaces to the models using MOF-compliant Unified Modeling Language (UML) can have the interfaces to the models automatically generated. Using this generated set of APIs, applications can access (create, delete, update and retrieve) information contained in a MOF compliant model.

Turning now to FIG. 2, a flow diagram that illustrates using manually coded Java™ Metadata Interface (JMI) interfaces to access a metamodel is presented. At 200 a repository receives a metamodel. At 205 the repository automatically generates JMI interfaces for the metamodel. At 210 a repository user manually develops the software implementation for the JMI interfaces generated at reference numeral 205. At 215 the repository user compiles the coded JMI interface implementations. At 220 the repository user uses the compiled JMI interface implementations to access the metamodel.

FIG. 3 is a flow diagram that illustrates a typical method for generating JMI interfaces for a metamodel. FIG. 3 provides more detail for reference numeral 205 of FIG. 2. At 300 a package proxy interface is generated for each object of type “Package”. Sample package proxy interface 305 includes accessor methods 310, 315 for each class proxy in the package. Each accessor method name has a “get” prefix and a “Class” suffix. Package proxy interface 305 also includes methods getAssociationName1 (302) and getAssociationName2 (304) that return the association proxy objects for association1 and association2, respectively. Package proxy interface 305 also includes methods getPackageName1 306 and getPackageName2 (308) that return the package proxy object for package1 and package2, respectively. The package proxy interface name includes the package name followed by “Package”.

At 320 a class proxy interface is generated for each object of type “Class”. Sample class proxy interface 325 includes factory methods 330, 335 for a class. Each factory method name has a “create” prefix. The class proxy interface name includes the class name followed by “Class”. At 340 an instance interface is generated for each object of type “Class”. Sample instance interface 345 includes “get” and “set” methods for each attribute and reference. Sample instance interface 345 also includes operation methods (370, 375) for each operation. The instance interface name is the same as the class name.

At 380 an association proxy interface is generated for each object of type “Association”. Sample association proxy interface 385 includes “add” method 390 and “remove” method 395.

A MOF repository may change in several ways. These changes include changes to the repository data structures such as repository objects, metaobjects and meta-metaobjects. These data structures may be stored, read or updated. These changes or events often impact clients of the repository.

For example, an attribute of an object may be altered. A client, however, may be accessing the object frequently. Use of the object without knowledge of the change may case errors or delays in the client's software. Thus, it is important that the client be made aware of the change.

Furthermore, there may be some events which impact the client so much that the client should be able to override or veto the change before it occurs. Thus, it would be beneficial if on top of alerting a client once an event occurs there is some mechanism for alerting the client before the event occurs and providing some means for the client to veto the event.

What is needed is a solution that provides event notification to clients of a MOF repository. A further need exists for such a solution that provides such notification before the events occur. Yet another need exists for such a solution that allows a MOF repository client to prevent the event occurrence.

### BRIEF DESCRIPTION OF THE INVENTION

Meta object facility repository event notification may be accomplished through the use of listener interfaces implemented by event listeners and event source interfaces implemented by objects at the repository. The listeners may register for event notifications of a particular type by passing a registration call for the event type to an appropriate event source interface. Additionally, listeners may register for listening to event notifications of any combination of event sub-types by passing a registration call (together with a bitmask indicating the event sub-types combinations) to a combination event type source interface. If an event occurs, an event object (describing the occurred event) is created by the event source and then it is passed via a notification call to each of the listeners registered for notifications of this particular event type or sub-type. This provides notification of the occurrence of events to the listeners.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1A is a block diagram that illustrates a four-layer architecture used to describe metamodeling.

FIG. 1B is a table that describes each of the layers illustrated in FIG. 1A.

FIG. 2 is a flow diagram that illustrates using manually coded Java™ Metadata Interface (JMI) interfaces to access a metamodel.

FIG. 3 is a flow diagram that illustrates generating JMI interfaces for a metamodel.

FIG. 4 is a block diagram of a client computer system suitable for implementing aspects of the present invention.

FIG. 5 is a block diagram that illustrates interfaces and objects used for event notification in accordance with one embodiment of the present invention.

FIG. 6A is a block diagram that illustrates a class hierarchy in accordance with one embodiment of the present invention.

FIG. 6B is a block diagram that illustrates a class hierarchy in accordance with one embodiment of the present invention.

FIG. 7 is a flow diagram that illustrates a method for event firing in accordance with one embodiment of the present invention.

FIG. 8 is a block diagram of a MOF repository in accordance with one embodiment of the present invention.

FIG. 9 is a flow diagram that illustrates a method for generating JMI interface implemetations that include event source interfaces in accordance with one embodiment of the present invention.

FIG. 10 is a flow diagram that illustrates a method for developing the software implementation for JMI interfaces in accordance with one embodiment of the present invention.

FIG. 11 is a block diagram that illustrates event dispatching and event registration in accordance with one embodiment of the present invention.

FIG. 12 is a flow diagram that illustrates a method for notifying one or more listeners of an event in a meta object facility repository, the event having an event type and sub-type, in accordance with one embodiment of the present invention.

FIG. 13 is a flow diagram that illustrates a method for registering for event notification of an event in a meta object facility repository (MOF), the event having an event type, in accordance with one embodiment of the present invention.

FIG. 14 is a flow diagram that illustrates a method for registering for event notification of an event in a meta object facility repository (MOF), the event having an event type and event sub-type, in accordance with one embodiment of the present invention.

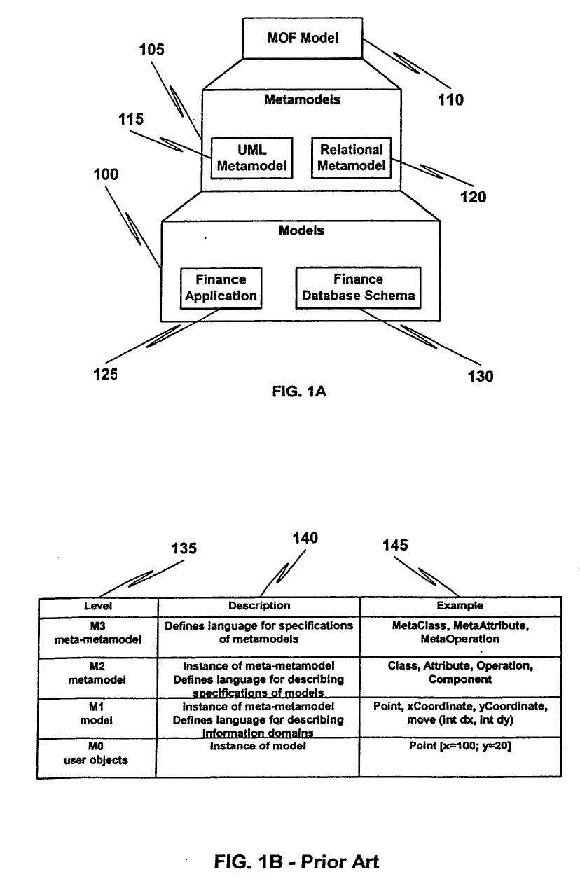

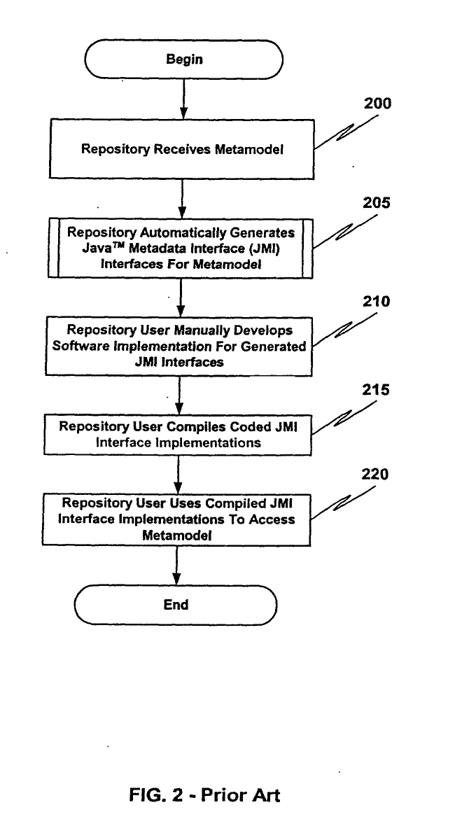

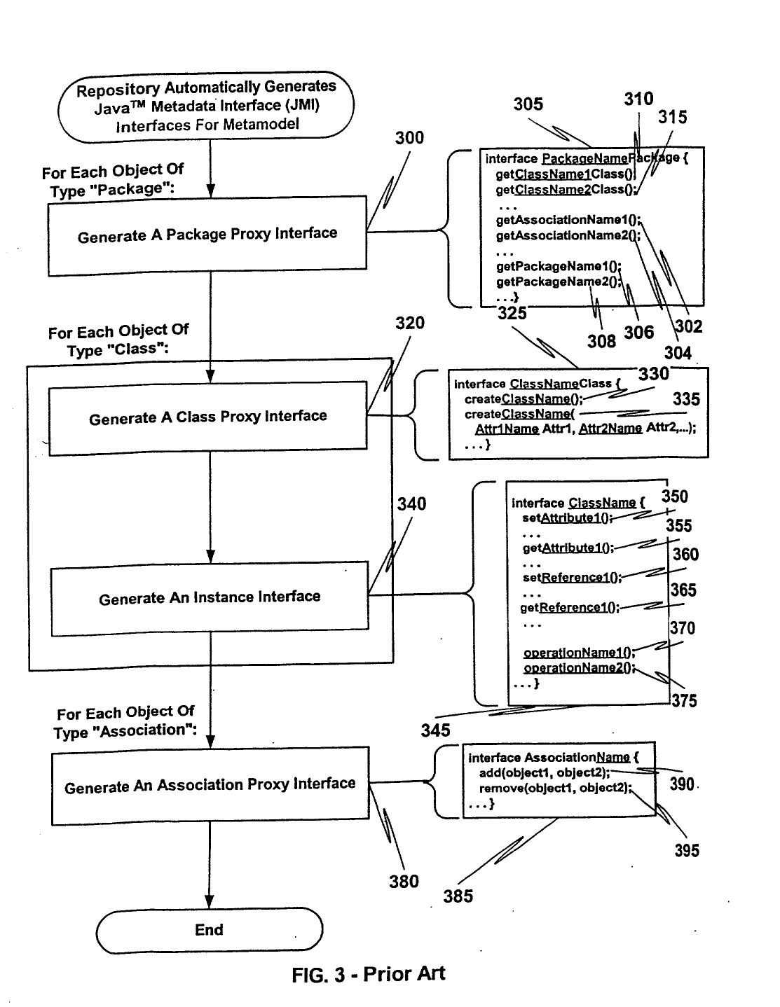

### DETAILED DESCRIPTION OF A PREFERRED EMBODIMENT

Embodiments of the present invention are described herein in the context of a method and apparatus for Meta Object Facility repository event notification. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In the context of the present invention, the term “network” includes local area networks, wide area networks, the Internet, cable television systems, telephone systems, wireless telecommunications systems, fiber optic networks, ATM networks, frame relay networks, satellite communications systems, and the like. Such networks are well known in the art and consequently are not further described here.

In accordance with one embodiment of the present invention, the components, processes and/or data structures may be implemented using Java™ programs running on high performance computers (such as an Enterprise 2000™ server running Sun Solaris™ as its operating system. The Enterprise 2000™ server and Sun Solaris™ operating system are products available from Sun Microsystems, Inc. of Mountain View, Calif.). Different implementations may be used and may include other types of object-oriented languages, operating systems, computing platforms, computer programs, firmware, computer languages and/or general-purpose machines. In addition, those of ordinary skill in the art will readily recognize that devices of a less general purpose nature, such as hardwired devices, devices relying on FPGA (field programmable gate array) or ASIC (Application Specific Integrated Circuit) technology, or the like, may also be used without departing from the scope and spirit of the inventive concepts disclosed herein.

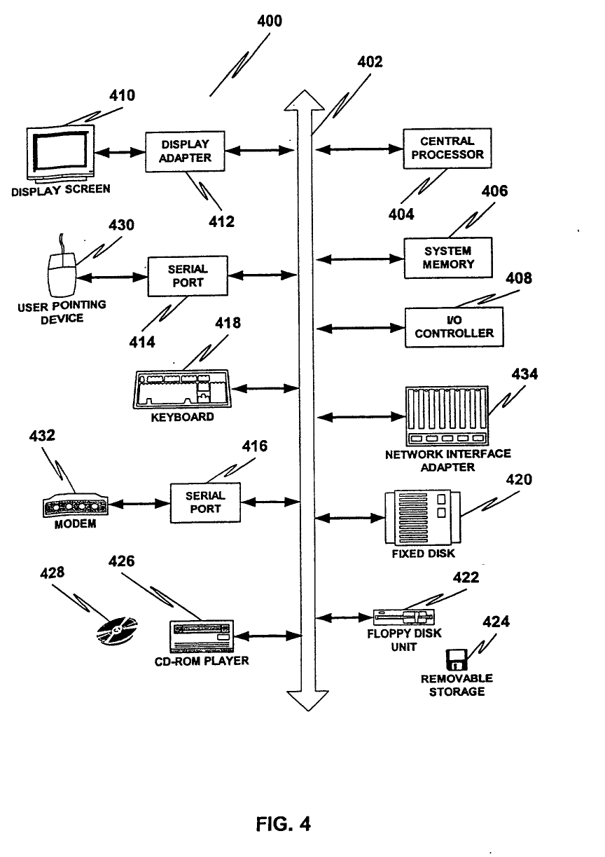

FIG. 4 depicts a block diagram of a computer system 400 suitable for implementing aspects of the present invention. As shown in FIG. 4, computer system 400 includes a bus 402 which interconnects major subsystems such as a central processor 404, a system memory 406 (typically RAM), an input/output (I/O) controller 408, an external device such as a display screen 410 via display adapter 412, serial ports 414 and 416, a keyboard 418, a fixed disk drive 420, a floppy disk drive 422 operative to receive a floppy disk 424, and a CD-ROM player 426 operative to receive a CD-ROM 428. Many other devices can be connected, such as a pointing device 430 (e.g., a mouse) connected via serial port 414 and a modem 432 connected via serial port 416. Modem 432 may provide a direct connection to a remote server via a telephone link or to the Internet via a POP (point of presence). Alternatively, a network interface adapter 434 may be used to interface to a local or wide area network using any network interface system known to those skilled in the art (e.g., Ethernet, xDSL, AppleTalk™).

Many other devices or subsystems (not shown) may be connected in a similar manner. Also, it is not necessary for all of the devices shown in FIG. 4 to be present to practice the present invention, as discussed below. Furthermore, the devices and subsystems may be interconnected in different ways from that shown in FIG. 4. The operation of a computer system such as that shown in FIG. 4 is readily known in the art and is not discussed in detail in this application, so as not to overcomplicate the present discussion. Code to implement the present invention may be operably disposed in system memory 406 or stored on storage media such as fixed disk 420, floppy disk 424 or CD-ROM 428.

According to embodiments of the present invention, clients of a MOF repository are notified of repository events through the use of an event notification interface. A separate interface may exist for each type of event to be monitored. The clients may be notified before the events occur, allowing the client to prevent the event occurrence.

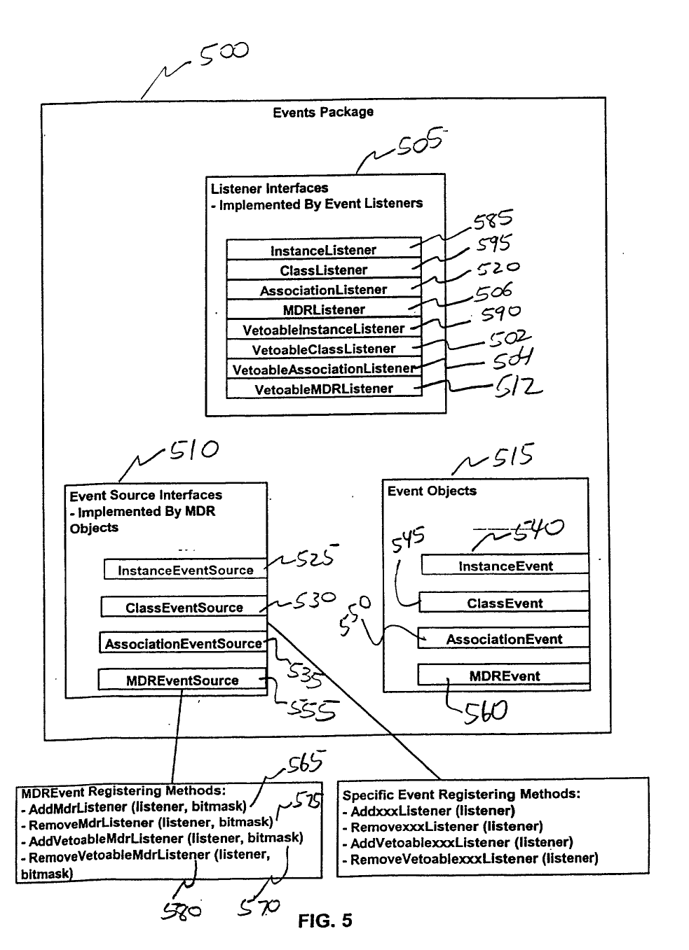

Turning now to FIG. 5, a block diagram that illustrates interfaces and objects used for event notification in accordance with one embodiment of the present invention is presented. Events package 500 includes listener interfaces 505, event source interfaces 510 and event objects 515. The listener interfaces 505 are implemented by event listeners, the parties or companies that are requesting notification of certain events in the repository. The listener interfaces 505 enable clients of the repository to listen to multiple event notifications. Event source interfaces 510 are implemented by repository objects. The event source interfaces 510 enable clients to register themselves as listeners for particular events.

According to embodiments of the present invention, two types of listener interfaces are supported. “Change” listener interfaces allow a user to be notified about a change after the change has occurred. A “Vetoable change” listener interface allows a user to be notified about a change before it occurs, enabling the client to veto the change and thus prevent its occurrence. The listener interfaces include methods (not shown in FIG. 5) for particular types of event notification. For example, the AssociationListener 520 defines one method (associationChange) for event notifications.

According to embodiments of the present invention, events may have a type and/or sub-type. For purposes of this application, a type of an event is a general category of events to which the event belongs. Examples of event types include instance events, class events, and association events. Again, for purposes of this application, a sub-type of an event is the precise type of event within the broader category of type. Thus, examples of sub-types include association add, association modify, and association remove, all sub-types of the broader type “association events”. However, one of ordinary skill in the art will recognize that type and sub-type may reasonably be interpreted to include many different category types and sub-types and various groupings thereof.

According to embodiments of the present invention, three event types and a combination event type are supported. The three specific event types are instance events, class events and association events. Instance events occur when instance-level attributes or references are changed, or when an instance-level operation is invoked. Class events occur when a new instance of a class is created, when an instance of a class is deleted, when a classifier-level attribute is changed or when a classifier-level operation is invoked. Association events occur when the collection of association links is changed.

According to embodiments of the present invention, there is an event source interface and an event object for each event type. For the purposes of this disclosure, the event source interfaces are referred to as InstanceEventSource 525 (for instance events), ClassEventSource 530 (for class events) and AssociationEventSource 535 (for association events). The event objects are referred to as InstanceEvent 540, ClassEvent 545 and AssociationEvent 550. As shown in FIG. 5, the event source interfaces 525, 530, 535, 555 include methods to register (add) (565, 570) and unregister (remove) (575, 580) change listeners. Separate methods are included for vetoable change listeners (570, 580).

In order to listen to instance events, a client object must first implement the InstanceListener 585 and/or VetoableInstanceListener 590 interfaces. Likewise, listening to class events requires implementing the ClassListener 595 and/or VetoableClassListener 502 interfaces and listening to association events requires implementing the AssociationListener 520 and/or VetoableAssociationListener 504 interfaces.

According to embodiments of the present invention, a unique identifer (ID) is provided for each event. The ID may be used to refine the granularity of events. For example, as mentioned above, the AssociationListener 520 defines only one method (associationChange) for event notifications even though there are many types of changes to associations. An association change may include adding a new link, adding a new link before an existing link, modifying an existing link and removing the link. Thus, each of these events is associated with a unique event ID corresponding to the event that caused the change. The associationChange IDs may be represented as:

EVENT_ASSOCIATION_ADD

EVENT_ASSOCIATION_ADD_BEFORE

EVENT_ASSOCIATION_MODIFY

EVENT_ASSOCIATION_REMOVE

A user may implement the AssociationListener 520 such that a check is made to determine the event ID and take appropriate action. According to embodiments of the present invention, the user obtains the event ID by calling the “getID” method of the event passed to the listener's method.

The combination event type (hereinafter referred to as “MdrEvent”) referred to above allows clients to register themselves to listen to any combination of MDR events of any sub-type. The subset is specified by a bitmask of event IDs. According to embodiments of the present invention, the event ID bitmasks are selected such that a bitwise “or” operation may be used to combine multiple event IDs into one number without losing the ability to determine which event IDs the number represents. Additionally, each event object includes a “isOfType” method that determines whether the object is part of the bitmask.

Similar to the specific event listeners, listening to MdrEvents requires the client object implement the MdrListener and/or VetoableMdrListener interfaces. For example, suppose a user wants to listen only to “add” and “remove” association events. The user could implement the AssociationListener interface 520 and examine the event ID in the associationChange method as described previously. Alternatively, the user could implement the MdrListener interface 506 and register a listener implementing the interface by passing an appropriate bitmask to the MdrEventSource.addMdrListener. Using the event IDs discussed above, the bitmask would be set to EVENT_ASSOCIATION_ADD|EVENT_ASSOCIATION_ADD_BEFORE|EVENT_ASSOCIATION_REMOVE, where the “|” indicates a bitwise “or” operation.

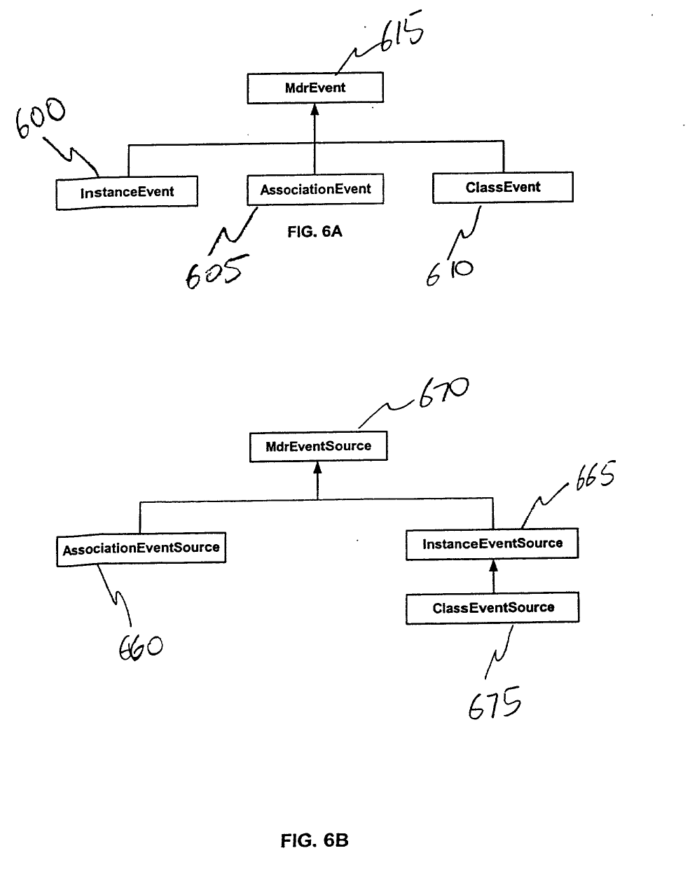

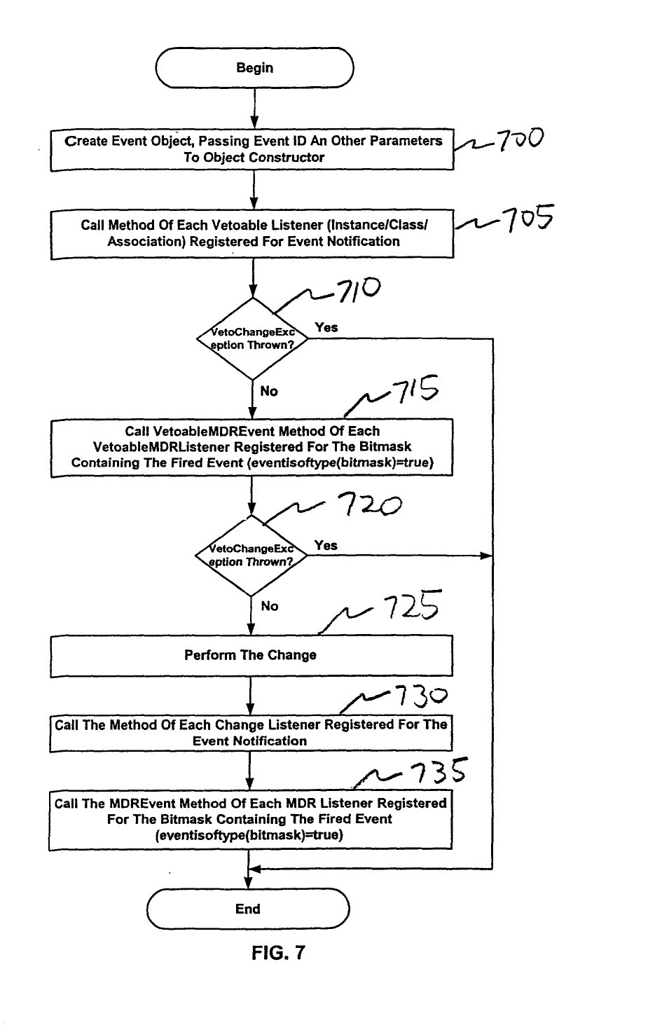

FIGS. 6A and 6B illustrate class hierarchies of interfaces and classes in the events package in accordance with embodiments of the present invention. As shown in FIG. 6A, each specific event object (600, 605, 610) inherits from MdrEvent 615. As shown in FIG. 6B, interfaces AssociationEventSource 660 and InstanceEventSource 665 inherit from interface MdrEventSource 670, and interface ClassEventSource 675 inherits from both InstanceEventSource 665 and MdrEventSource 670. Since each event object (600, 605, 610) is a decendent of MdrEvent 615, the MdrListener will always receive the same event object as the specific event listener. Event firing is discussed below in more detail with reference to FIG. 7.

Turning now to FIG. 7, a flow diagram that illustrates a method for event firing in accordance with one embodiment of the present invention is presented. At 700 an event object is created, including the event ID as a parameter. At 705 the appropriate method of each vetoable listener registered for event notification is called. At 710 a determination is made regarding whether any of the vetoable listeners has thrown VetoChangeException. If any of the listeners has thrown VetoChangeException, the change is not made. At 715 the VetoableMdrEvent method of each VetoableMdrListener registered for the bitmask containing the fired event is called. At 720 a determination is made regarding whether any of the vetoable listeners has thrown VetoChangeException. If any of the listeners has thrown VetoChangeException, the change is not made. At 725 the change is made. At 730 the method of each change listener registered for event notification is called. At 735 the MdrEvent method of each MDR listener registered for the bitmask containing the fired event is called.

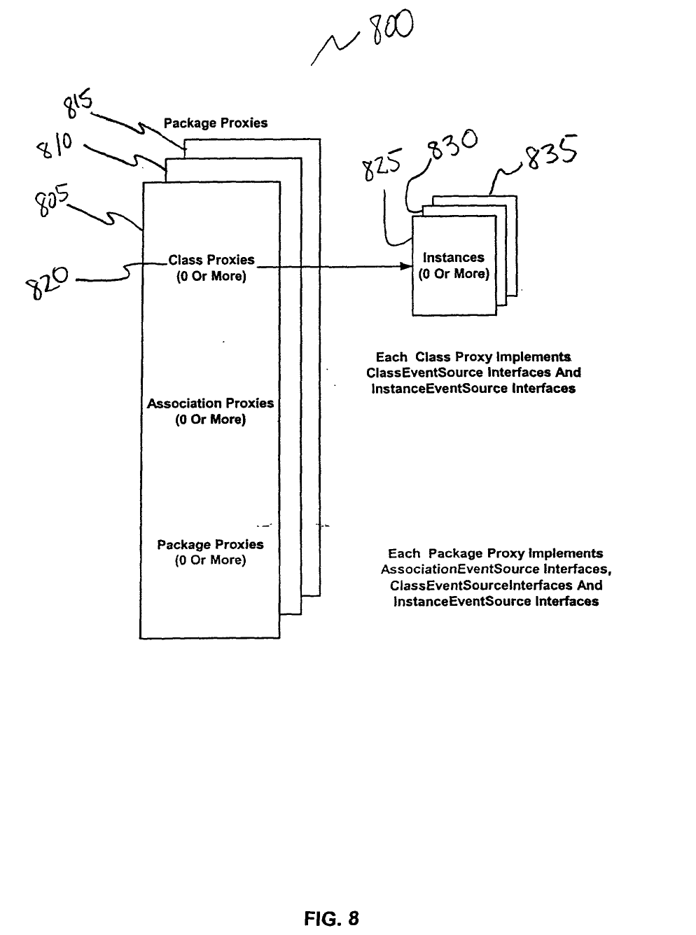

Turning now to FIG. 8, a block diagram of a MOF repository in accordance with one embodiment of the present invention is presented. MOF repository 800 includes one or more package proxies 805, 810, 815. Each package proxy implements AssociationEventSource interface, ClassEventSource interface and InstanceEventSource interface. This feature facilitates the process of registering a listener on package-level events. For example, if a user wishes to listen to instance events regarding the entire package, the user calls the addInstanceListener method provided by the package. In this case, the user will receive events from all instances associated with all class proxies in the package.

Still referring to FIG. 8, each package proxy includes zero or more class proxies 820. Each class proxy 820 is associated with zero or more instances 825, 830, 835. Each class proxy 820 implements ClassEventSource interface. Each class proxy 820 also implements InstanceEventSource interface because ClassEventSource interface inherits from InstanceEventSource interface. A user that registers for listening to instance interfaces on the class proxy will receive all events related to all instances associated with the class proxy. This feature is particularly advantageous because the user need not examine all the instances associated with a particular class proxy and register separately for event listening on each of the instances.

According to one embodiment of the present invention, a “EventNotifier” class handles the registration of listeners and event dispatching. To register a listener for listening (e.g. to class proxy events of a particular class proxy object), the class proxy forwards the registration call to the EventNotifier class. The EventNotifier class maintains a record of which listener is registered for listening to which events. When an event must be fired (e.g. when an attempt is made to change the value of an attribute of an instance), rather than handling the vetoable event notification itself, the instance calls EventNotifier, indicating that a vetoableChange event must be fired on each listener that listens to the particular instance. Then the instance performs the change and calls EventNotifier again, indicating that the change event must be fired on each listener that listens to the particular instance. Thus, the event firing described with reference to FIG. 7 need only be implemented in EventNotifier, rather than being implemented in each instance, class proxy, association proxy and package proxy implementation. Accordingly, less memory is used according to this embodiment of the present invention because only one record of the registration is maintained for all the instances on the class proxy.

A further advantage of this approach is that the user can use only one implementation of MdrListener to listen to multiple types of events.

Another example of registering for listening to several objects in one place is as follows. Suppose a user would like to be notified whenever a new instance of a class is created (event ID=ClassEvent.EVENT_CLASS_CREATE) and whenever any instances of the class are changed (event ID=InstanceEvent.EVENT_CHANGE). This may be accomplished by registering an MdrListener on the class proxy with the bitmask set to ClassEvent.EVENT_CLASS_CREATE|InstanceEvent.EVENT_CHANGE.

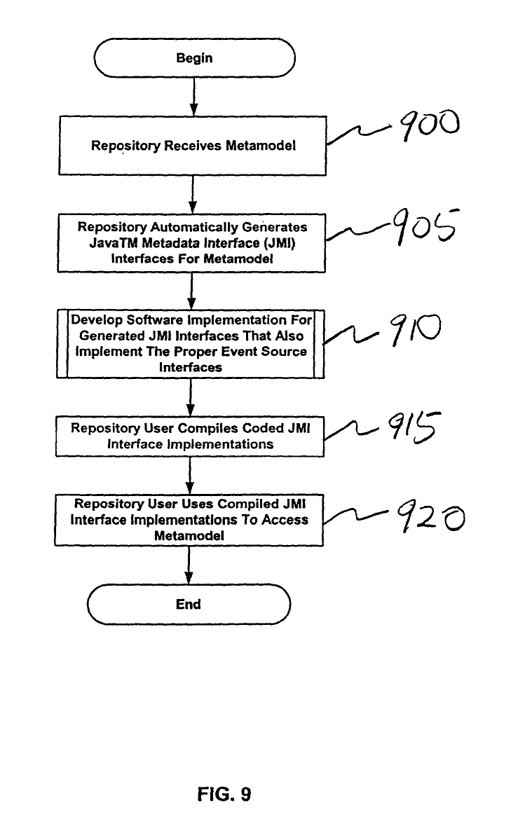

Turning now to FIG. 9, a flow diagram that illustrates a method for generating JMI interface implemetations that also implement event source interfaces in accordance with one embodiment of the present invention is presented. At 900 a repository receives a metamodel. At 905 the repository generates JMI interfaces for the metamodel. At 910 a repository user develops the software implementation of JMI interfaces such that the implementation of each JMI interface also implements the proper event source interface. The software implementation includes event source interfaces. The JMI interface implementations are preferably generated automatically. At 915 the repository user compiles the coded JMI interface implementations. At 920 the repository user uses the compiled JMI interface implementations to access the metamodel.

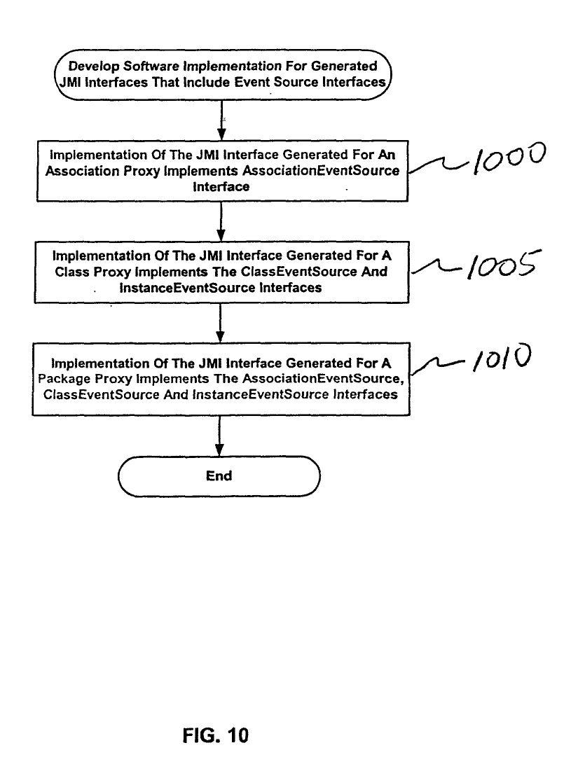

Turning now to FIG. 10, a flow diagram that illustrates a method for developing the software implementation for JMI interfaces in accordance with one embodiment of the present invention is presented. FIG. 10 provides more detail for reference numeral 910 of FIG. 9. At 1000 an implementation of the JMI interface generated for an association proxy implements AssociationEventSource interface. At 1005 an implementation of the JMI interface generated for a class proxy implements the ClassEventSource and InstanceEventSource interfaces. At 1010 an implementation of the JMI interface generated for a package proxy implements the AssociationEventSource, ClassEventSource and InstanceEventSource interfaces.

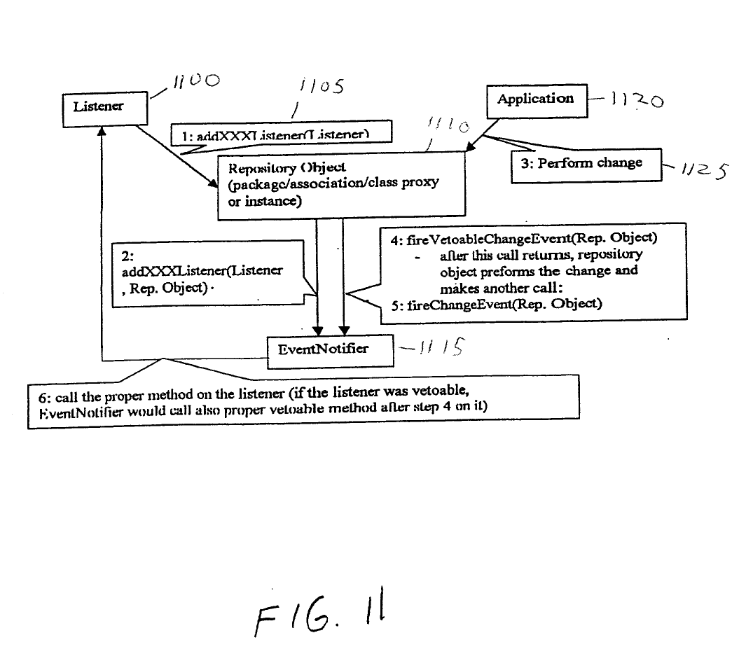

FIG. 11 is a block diagram that illustrates event dispatching and event registration in accordance with one embodiment of the present invention. Listener 1100 passes a registration call 1105 to the repository object 1110 corresponding to the appropriate event type. The repository object 1110 then passes reference to itself together with the reference to the registering listener to the event notifier 1115, which then waits for an event to be performed. Then at any time, an application 1120 may request a repository object to perform a change (event) 1125. The repository object then calls fireVetoableChangeEvent to produce notifications to listeners that the change is about to be performed. If some of the listeners veto the change by raising a VetoChangeException, the processing of the change is stopped without performing the change. If none of the listeners veto the change, the repository object performs the requested change and calls the fireChangeEvent method of the event notifier 1115 to produce notifications to listeners.

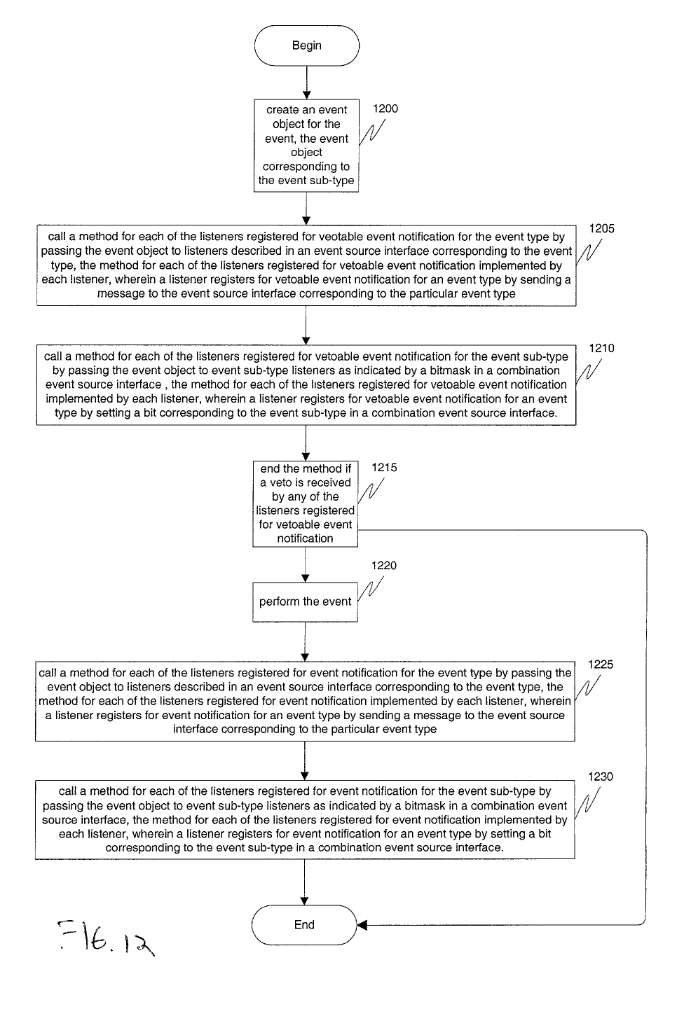

FIG. 12 is a flow diagram that illustrates a method for notifying one or more listeners of an event in a meta object facility repository, the event having an event type and sub-type, in accordance with one embodiment of the present invention. At 1200, an event object is created for the event, the event object corresponding to the event sub-type. At 1205, a method is called for each of the listeners registered for vetoable event notification for the event type by passing said event object to listeners described in an event source interface corresponding to the event type, the method for each of the listeners registered for vetoable event notification implemented by each listener, wherein a listener registers for vetoable event notification for an event type by sending a message to said event source interface corresponding to said particular event type. At 1210, a method is called for each of the listeners registered for vetoable event notification for the event sub-type by passing said event object to event sub-type listeners as indicated by a bit-mask in a combination event source interface, the method for each of the listeners registered for vetoable event notification implemented by each listener, wherein a listener registers for vetoable event notification for an event type by setting a bit corresponding to the event sub-type in said combination event source interface.

At 1215, the method for notifying is ended if a veto is received by any of the listeners registered for vetoable event notification. At 1220, the event is performed. At 1225, a method is called for each of the listeners registered for event notification for the event type by passing said event object to listeners described in an event source interface corresponding to the event type, the method for each of the listeners registered for event notification implemented by each listener, wherein a listener registers for event notification for an event type by sending a message to said event source interface corresponding to said particular event type. At 1230, a method is called for each of the listeners registered for event notification for the event sub-type by passing said event object to event sub-type listeners as indicated a bit-mask in a combination event source interface, the method for each of the listeners registered for event notification implemented by each listener, wherein a listener registers for event notification for an event type by setting a bit corresponding to the event sub-type in said combniation event source interface.

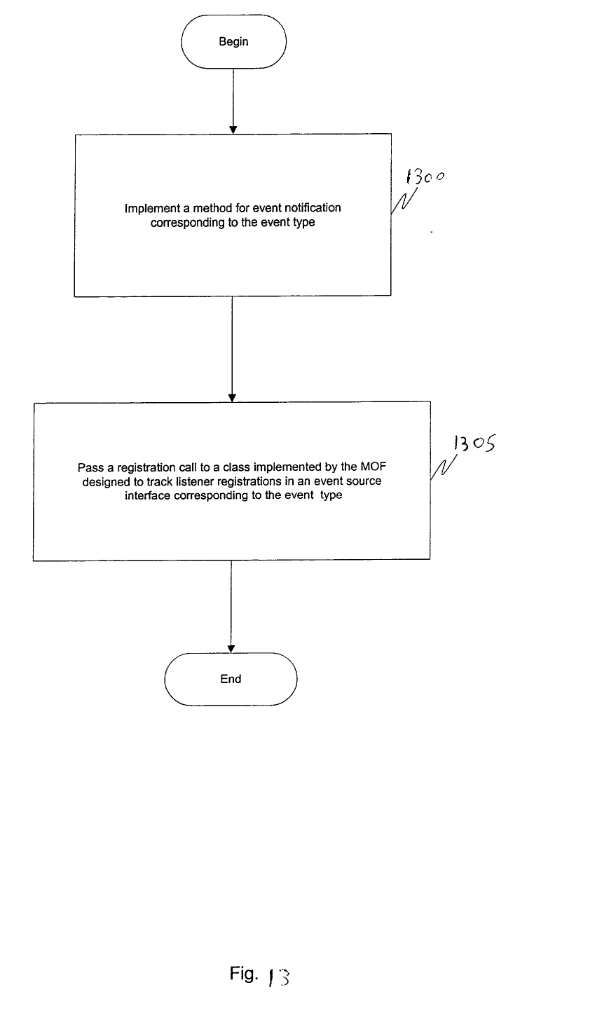

FIG. 13 is a flow diagram that illustrates a method for registering for event notification of an event in a meta object facility repository (MOF), the event having an event type, in accordance with one embodiment of the present invention. At 1300, a method is implemented for event notification corresponding to the event type. At 1305, a registration call is passed to a class implemented by the MOF designed to track listener registrations in an event source interface corresponding to the event type.

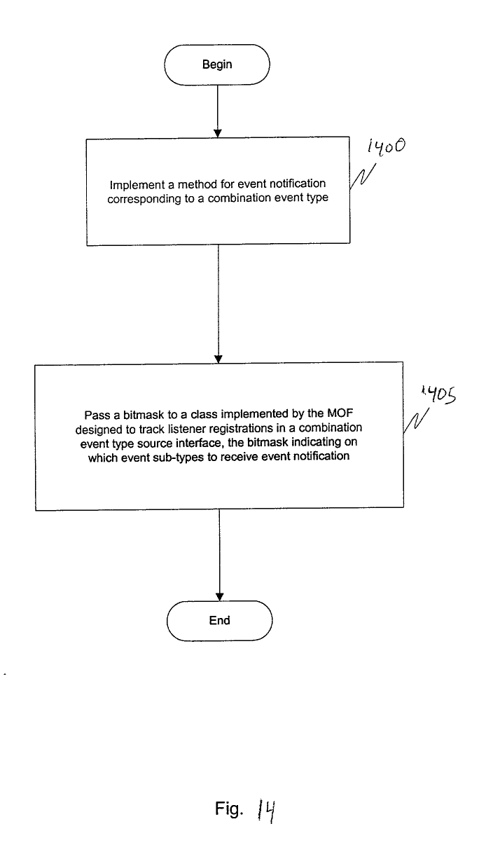

FIG. 14 is a flow diagram that illustrates a method for registering for event notification of an event in a meta object facility repository (MOF), the event having an event type and event sub-type, in accordance with one embodiment of the present invention. At 1400, a method is implemented for event notification corresponding to a combination event type. At 1402, a bitmask is passed to a class implemented by the MOF designed to track listener registrations in a combination event type source interface, the bitmask indicating on which event sub-types to receive event notification.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for notifying one or more listeners of an event in a meta object facility repository (MOF), the event having an event type, the method including:
creating an event object for the event, the event object corresponding to the event sub-type;
performing the event;
calling a method for each of the listeners registered for event notification for the event type by passing said event object to listeners described in an event source interface corresponding to the event type, said method for each of the listeners registered for event notification implemented by each listener.

2. The method of claim 1, wherein a listener registers for event notification by passing a registration call to a class implemented by the MOF designed to track listener registrations in said event source interface corresponding to the event type.

3. The method of claim 2, wherein said class implemented by the MOF corresponds only to the event type.

4. The method of claim 2, wherein said class implemented by the MOF maintains a record of which listener is registered for notification of which events.

5. The method of claim 1, wherein the event type is a class, instance, or association.

6. The method of claim 1, further including calling a method for each of the listeners registered for event notification for the event sub-type by passing the event object to event sub-type listeners as indicated by a bitmask in a combination event source interface, the method for each of the listeners registered for event notification implemented by each listener, wherein a listener registers for event notification for an event type by setting a bit corresponding to the event sub-type in a combination event source interface.

7. The method of claim 1, further including:
calling a method for each of the listeners registered for vetoable event notification for the event type by passing said event object to listeners described in an event source interface corresponding to the event type, said method for each of the listeners registered for vetoable event notification implemented by each listener; and
ending said method for notifying before said performing the event if a veto is received by any of said listeners registered for vetoable event notification.

8. The method of claim 7, wherein a listener registers for vetoable event notification by passing a registration call to a class implemented by the MOF designed to track listener registrations in said event source interface corresponding to the event type.

9. The method of claim 8, wherein said class implemented by the MOF corresponds only to the event type.

10. The method of claim 8, wherein said class implemented by the MOF maintains a record of which listener is registered for notification of which events.

11. The method of claim 7, further including:
calling a method for each of the listeners registered for vetoable event notification for the event sub-type by passing the event object to event sub-type listeners as indicated by a bitmask in a combination event source interface, the method for each of the listeners registered for vetoable event notification implemented by each listener, wherein a listener registers for vetoable event notification for an event type by setting a bit corresponding to the event sub-type in a combination event source interface.

12. A method for notifying one or more listeners of an event in a meta object facility repository (MOF), the event having an event type, the method including:
creating an event object for the event, the event object corresponding to the event sub-type;
performing the event; and
calling a method for each of the listeners registered for event notification for the event sub-type by passing the event object to event sub-type listeners as indicated by a bitmask in a combination event source interface, the method for each of the listeners registered for event notification implemented by each listener, wherein a listener registers for event notification for an event type by setting a bit corresponding to the event sub-type in a combination event source interface.

13. A method for registering for event notification of an event in a meta object facility repository (MOF), the event having an event type, the method including:
implementing a method for event notification corresponding to the event type;
passing a registration call to a class implemented by the MOF designed to track listener registrations in an event source interface corresponding to the event type.

14. A method for registering for event notification of an event in a meta object facility repository (MOF), the event having an event type and event sub-type, the method including:
implementing a method for event notification corresponding to a combination event type;
passing a bitmask to a class implemented by the MOF designed to track listener registrations in a combination event type source interface, the bitmask indicating on which event sub-types to receive event notification.

15. An apparatus for notifying one or more listeners of an event in a meta object facility repository (MOF), the event having an event type and sub-type, the apparatus including:
an event source interface corresponding to the event type; and
a memory storing an event object, said event object corresponding to the event sub-type, said memory coupled to said event source interface.

16. The apparatus of claim 15, wherein said event source interface is designed to call a method for each of the users registered for event notification for the event type by passing said event object to listeners described in said event source interface, said method for each of the listeners registered for event notification implemented by each listener.

17. The apparatus of claim 15, wherein said event source interface contains a second memory storing a record of which listener is registered for notification of which events.

18. The apparatus of claim 17, wherein said second memory further contains a class designed to track listener registration.

19. The apparatus of claim 18, wherein said class corresponds only to the event type.

20. The apparatus of claim 15, wherein said event source interface is further designed to call a method for each of the listeners registered for vetoable event notification before the event is performed and prevent the event from being performed if a veto is received by any of the listeners registered for vetoable event notification.

21. An apparatus for notifying one or more listeners of an event in a meta object facility repository (MOF), the event having an event type and an event sub-type, the apparatus including:
a combination event type source interface; and
a memory storing an combination event object, said memory coupled to said combination event type source interface.

22. The apparatus of claim 21, wherein said combination event source interface is designed to call a method for each of the users registered for event notification for the event sub-type by passing said combination event object to event sub-type listeners as indicated by a bimask stored a second memory coupled to said combination event type source interface, said method for each of the listeners registered for event notification implemented by each listener.

23. The apparatus of claim 21, wherein said combination event source interface is further designed to call a method for each of the users registered for vetoable event notification for the event sub-type by passing said combination event object to event sub-type listeners as indicated by a bimask stored a second memory coupled to said combination event type source interface, said method for each of the listeners registered for vetoable event notification implemented by each listener.

24. An apparatus for registering for event notification of an event in a meta object facility repository (MOF), the event having an event type, the apparatus including:
a listener interface implementing a method for event notification corresponding to the event type; and
means for passing a registration call to a class implemented by the MOF designed to track listener registrations in an event source interface corresponding to the event type.

25. An apparatus for registering for event notification of an event in a meta object facility repository (MOF), the event having an event type and event sub-type, the apparatus including:
a listener interface implementing a method for event notification corresponding to a combination event type; and
means for passing a bitmask to a class implemented by the MOF designed to track listener registrations in a combination event type source interface, the bitmask indicating on which event sub-types to receive event notification.

26. An apparatus for notifying one or more listeners of an event in a meta object facility repository (MOF), the event having an event type, the apparatus including:
means for creating an event object for the event, the event object corresponding to the event sub-type;
means for performing the event;
means for calling a method for each of the listeners registered for event notification for the event type by passing said event object to listeners described in an event source interface corresponding to the event type, said method for each of the listeners registered for event notification implemented by each listener.

27. The apparatus of claim 25, wherein a listener registers for event notification by passing a registration call to a class implemented by the MOF designed to track listener registrations in said event source interface corresponding to the event type.

28. The apparatus of claim 27, wherein said class implemented by the MOF corresponds only to the event type.

29. The apparatus of claim 27, wherein said class implemented by the MOF maintains a record of which listener is registered for notification of which events.

30. The apparatus of claim 26, wherein the event type is a class, instance, or association.

31. The apparatus of claim 26, further including means for calling a method for each of the listeners registered for event notification for the event sub-type by passing the event object to event sub-type listeners as indicated by a bitmask in a combination event source interface, the method for each of the listeners registered for event notification implemented by each listener, wherein a listener registers for event notification for an event type by setting a bit corresponding to the event sub-type in a combination event source interface.

32. The apparatus of claim 26, further including:
means for calling a method for each of the listeners registered for vetoable event notification for the event type by passing said event object to listeners described in an event source interface corresponding to the event type, said method for each of the listeners registered for vetoable event notification implemented by each listener; and
means for ending said method for notifying before said performing the event if a veto is received by any of said listeners registered for vetoable event notification.

33. The apparatus of claim 32, wherein a listener registers for vetoable event notification by passing a registration call to a class implemented by the MOF designed to track listener registrations in said event source interface corresponding to the event type.

34. The apparatus of claim 33, wherein said class implemented by the MOF corresponds only to the event type.

35. The apparatus of claim 33, wherein said class implemented by the MOF maintains a record of which listener is registered for notification of which events.

36. The apparatus of claim 32, further including:
means for calling a method for each of the listeners registered for vetoable event notification for the event sub-type by passing the event object to event sub-type listeners as indicated by a bitmask in a combination event source interface, the method for each of the listeners registered for vetoable event notification implemented by each listener, wherein a listener registers for vetoable event notification for an event type by setting a bit corresponding to the event sub-type in a combination event source interface.

37. An apparatus for notifying one or more listeners of an event in a meta object facility repository (MOF), the event having an event type, the apparatus including:
creating an event object for the event, the event object corresponding to the event sub-type;
performing the event; and
calling a method for each of the listeners registered for event notification for the event sub-type by passing the event object to event sub-type listeners as indicated by a bitmask in a combination event source interface, the method for each of the listeners registered for event notification implemented by each listener, wherein a listener registers for event notification for an event type by setting a bit corresponding to the event sub-type in a combination event source interface.

38. An apparatus for registering for event notification of an event in a meta object facility repository (MOF), the event having an event type, the apparatus including:
means for implementing a method for event notification corresponding to the event type;
means for passing a registration call to a class implemented by the MOF designed to track listener registrations in an event source interface corresponding to the event type.

39. An apparatus for registering for event notification of an event in a meta object facility repository (MOF), the event having an event type and event sub-type, the method including:
means for implementing a method for event notification corresponding to a combination event type;
means for passing a bitmask to a class implemented by the MOF designed to track listener registrations in a combination event type source interface, the bitmask indicating on which event sub-types to receive event notification.

40. A program storage device readable by a machine, tangibly embodying a program of instructions executable by the machine to perform a method for notifying one or more listeners of an event in a meta object facility repository (MOF), the event having an event type, the method including:
creating an event object for the event, the event object corresponding to the event sub-type;
performing the event;
calling a method for each of the listeners registered for event notification for the event type by passing said event object to listeners described in an event source interface corresponding to the event type, said method for each of the listeners registered for event notification implemented by each listener.

41. A program storage device readable by a machine, tangibly embodying a program of instructions executable by the machine to perform a method for notifying one or more listeners of an event in a meta object facility repository (MOF), the event having an event type, the method including:
creating an event object for the event, the event object corresponding to the event sub-type;
performing the event; and
calling a method for each of the listeners registered for event notification for the event sub-type by passing the event object to event sub-type listeners as indicated by a bitmask in a combination event source interface, the method for each of the listeners registered for event notification implemented by each listener, wherein a listener registers for event notification for an event type by setting a bit corresponding to the event sub-type in a combination event source interface.

42. A program storage device readable by a machine, tangibly embodying a program of instructions executable by the machine to perform a method for registering for event notification of an event in a meta object facility repository (MOF), the event having an event type, the method including:
implementing a method for event notification corresponding to the event type;
passing a registration call to a class implemented by the MOF designed to track listener registrations in an event source interface corresponding to the event type.

43. A program storage device readable by a machine, tangibly embodying a program of instructions executable by the machine to perform a method for registering for event notification of an event in a meta object facility repository (MOF), the event having an event type and event sub-type, the method including:
implementing a method for event notification corresponding to a combination event type;
passing a bitmask to a class implemented by the MOF designed to track listener registrations in a combination event type source interface, the bitmask indicating on which event sub-types to receive event notification.
